(19) United States
(12) Patent Application Publication
(10) Pub. No.: US 2005/0138012 A1
(43) Pub. Date: Jun. 23, 2005

(54) Meta-data storage and access techniques

(76) Inventors: Robert J. Royer JR., Portland, OR (US); John I. Garney, Portland, OR (US); Sanjeev N. Trika, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/793,399

(22) Filed: Mar. 3, 2004

Related U.S. Application Data
(63) Continuation-in-part of application No. 10/746,949, filed on Dec. 23, 2003.

(51) Int. Cl. G06F 17/30

(52) U.S. Cl. 707/3

(57) ABSTRACT

Briefly, techniques to separate a file system and its related meta-data from associated data stored in a mass storage device and store the meta-data on a low latency random access storage device with approximately uniform access times.

### RELATED APPLICATION

This application is a continuation-in-part of U.S. Patent application Ser. No. 10/746,949 filed Dec. 23, 2003 with inventors Garney, Trika, and Royer Jr.

### FIELD

The subject matter disclosed herein generally relates to techniques for storing meta-data.

### DESCRIPTION OF RELATED ART

File systems are well known techniques to manage storage and retrieval of files. Examples file systems include, but are not limited to, Microsoft file allocation table (FAT), Unix, and the Linux file system “ext” family. File systems typically utilize meta-data. Meta-data may describe the content, quality, condition, and other characteristics of data associated with files. Examples of meta-data include, but are not limited to, directories, file allocation tables, security features, file-names and their linkage, keywords, date-of-creation/modification, author, permissions, and a preview image. Use of a rotating media storage device (e.g., a magnetic storage device) to store meta-data may be inefficient in terms of storage and retrieval speeds. It is desirable to increase the speed at which meta-data can be stored and retrieved.

### BRIEF DESCRIPTION OF THE DRAWINGS

FIG. 1 depicts an embodiment of a system that may use embodiments of the present invention.

FIG. 2 depicts a block diagram of a system in accordance with an embodiment of the present invention.

FIG. 3 depicts an example process that can be used to reserve region(s) in a storage device that stores meta-data, in accordance with an embodiment of the present invention.

FIG. 4 depicts examples of schemes that can be used for address mapping meta-data in a mass storage device and/or meta-data storage device, in accordance with embodiments of the present invention.

FIG. 5 depicts a process to access data and meta-data, in accordance with embodiments of the present invention.

FIG. 6 depicts a process to convert a logical block address to a physical address of a meta-data storage device, in accordance with embodiments of the present invention.

FIG. 7 depicts an example system in which some embodiments of the present invention may be used.

Note that use of the same reference numbers in different figures indicates the same or like elements.

### DETAILED DESCRIPTION

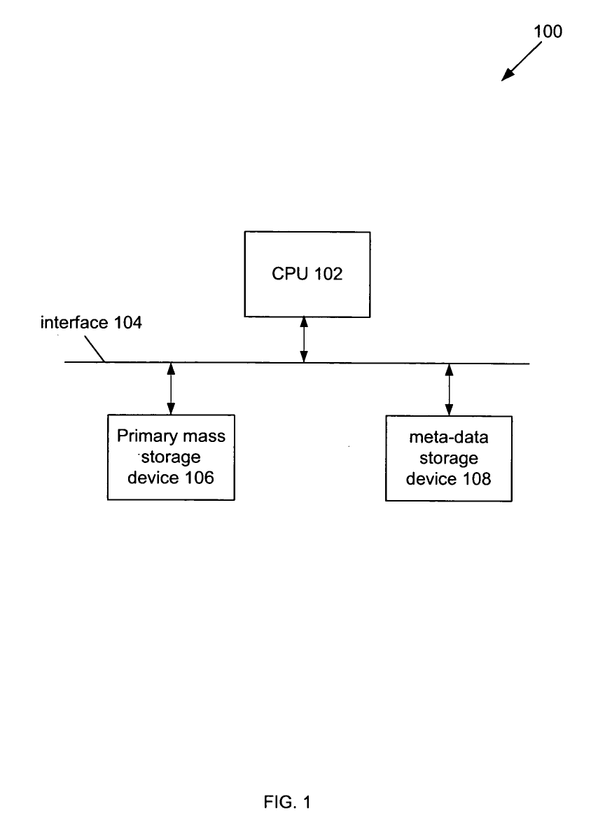

FIG. 1 depicts an embodiment of a system that may use embodiments of the present invention. System 100 may include a central processing unit (CPU) 102, interface 104, mass storage device 106, and meta-data storage device 108.

For example, interface 104 may be compatible with: Ten Gigabit Attachment Unit Interface (XAUI) (described in IEEE 802.3, IEEE 802.3ae, and related standards), universal serial bus (USB), IEEE 1394, Peripheral Component Interconnect (PCI) described for example at Peripheral Component Interconnect (PCI) Local Bus Specification, Revision 2.2, Dec. 18, 1998 available from the PCI Special Interest Group, Portland, Oregon, U.S.A. (as well as revisions thereof), PCI-x described in the PCI-X Specification Rev. 1.0a, Jul. 24, 2000, available from the aforesaid PCI Special Interest Group, Portland, Oreg., U.S.A. (as well as revisions thereof), ten bit interface (TBI), serial ATA described for example at “Serial ATA: High Speed Serialized AT Attachment,” Revision 1.0, published on Aug. 29, 2001 by the Serial ATA Working Group (as well as related standards), and/or parallel ATA (as well as related standards).

For example, mass storage device 106 may be implemented as any storage device including, but not limited to, a magnetic storage device or an array of magnetic storage devices. In one implementation, mass storage device 106 may store data and also may be used to store meta-data.

For example, meta-data storage device 108 may be implemented as a storage device with approximately uniform access times for randomly stored information (where an access time may be the time between receipt of a request by meta-data storage device 108 of a read or write operation and completion of such read or write operation). As compared to mass storage device 106, meta-data storage device 108 may have a lower average access time for randomly stored information. In one implementation, meta-data storage device 108 may store meta-data as well as an associated address mapping table that associates meta-data with storage locations in meta-data storage device 108 (or, possibly, mass storage device 106). For example, the address mapping table may describe meta-data using some of the following terms: (1) a logical block address; (2) an address in meta-data storage device 108 (or mass storage device 106, as the case may be); and (3) whether meta-data storage device 108 or mass storage device 106 stores the meta-data. Meta-data storage device 108 may further include storage regions for disk caching, reserved memory for application use, and reserved memory for a solid-state disk drive.

Although not a necessary feature or aspect of any embodiment of the present invention, storing meta-data in meta-data storage device 108 may provide an improvement over use of a rotating media storage device (e.g., a magnetic storage device) in terms of average storage and retrieval speeds for file-system operations that access meta-data (e.g., searching for a file by one or more fields in the meta-data (e.g., file-name, date of creation/revision, author name, or version number) or other operations such as directory listings).

In one embodiment, meta-data storage device 108 may be implemented as a non-volatile disk cache such as, e.g., a non-volatile polymer disk cache memory. For example, meta-data storage device 108 may be a ferroelectric polymer memory that may include an array of ferroelectric memory cells, wherein each cell may include a ferroelectric polymer memory material located between at least two conductive lines. The conductive lines may be referred to as address lines and may be used to apply an electric field across the ferroelectric polymer material to alter the polarization of the polymer material.

In this embodiment, meta-data storage device 108 may utilize the ferroelectric behavior of certain materials to retain data in a memory device in the form of positive and negative polarization, even in the absence of electric power. The ferroelectric polarizable material of each cell may contain domains of similarly oriented electric dipoles that retain their orientation unless disturbed by some externally imposed electric force. The polarization of the material characterizes the extent to which these domains are aligned. The polarization can be reversed by the application of an electric field of sufficient strength and polarity. In various embodiments, the ferroelectric polymer material may comprise a polyvinyl fluoride, a polyethylene fluoride, a polyvinyl chloride, a polyethylene chloride, a polyacrylonitrile, a polyamide, copolymers thereof, or combinations thereof. Polymer memories are sometimes referred to as plastic memories.

In an alternate embodiment, meta-data storage device 108 may be another type of polymer memory such as, for example, a resistive change polymer memory. In this embodiment, the polymer memory may include a thin film of non-volatile polymer memory material sandwiched at the nodes of an address matrix, e.g., a polymer memory material between two address lines. The resistance at any node may be altered from a few hundred ohms to several mega-ohms by applying an electric potential across the polymer memory material to apply a positive or negative current through the polymer material to alter the resistance of the polymer material. Potentially different resistance levels may store several bits per cell and data density may be increased further by stacking layers.

In another embodiment, meta-data storage device 108 may be implemented using a flash electrically erasable programmable read-only memory (EEPROM), which may be referred to simply as a flash memory. In yet another embodiment, meta-data storage device 108 may be implemented using a dynamic random access memory (DRAM) or a battery backed-up DRAM.

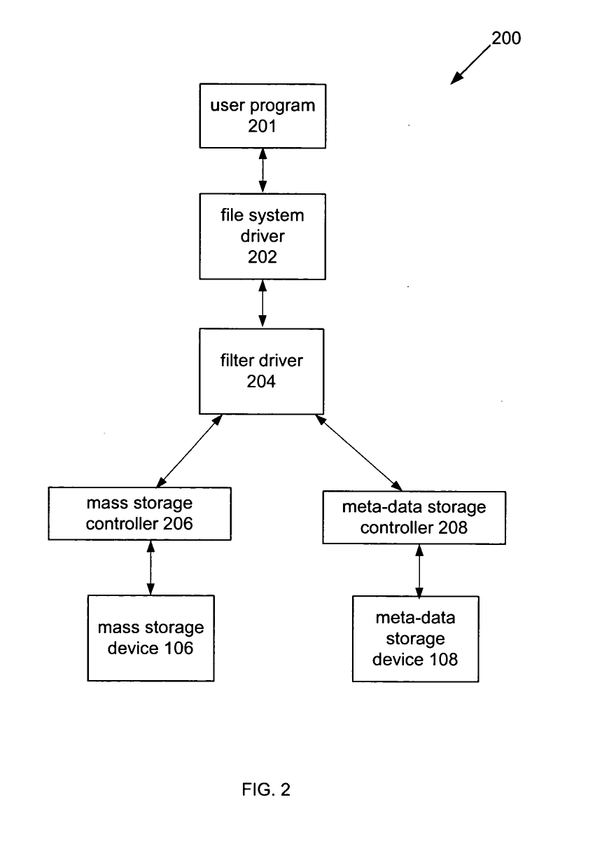

FIG. 2 depicts a block diagram of a system 200 in accordance with an embodiment of the present invention. System 200 may include user program 201, file system driver 202, filter driver 204, mass storage device controller 206, meta-data storage device controller 208, mass storage device 106, and meta-data storage device 108. User program 201, file system driver 202, filter driver 204, mass storage device controller 206, and meta-data storage device controller 208 may be implemented as any or a combination of hardwired logic, software stored by a memory device and executed by a microprocessor, firmware, an application specific integrated circuit (ASIC), and/or a field programmable gate array (FPGA).

User program 201 may request an operation (e.g., attempt to store, retrieve, or perform some other action) with respect to files stored in a storage device. To initiate actions with respect to files, user program 201 may provide a file name and/or file path as well as an associated action (e.g., read or write) to perform for the file.

In one embodiment, file system driver 202 may determine whether a requested operation accesses meta-data. For example, to satisfy a request from user program 201 of a file-level request operation (e.g., file name, file path, and requested action), file system driver 202 may use data structures and algorithms well understood in the art to determine (1) associated logical block addresses (LBAs), (2) whether an LBA-level request is for meta-data or data, as well as (3) sizes of any meta-data and data to retrieve or store to satisfy the request. For examples of techniques to associate meta-data with a requested file or directory, see publications describing the Microsoft FAT, Linux, and/or Unix. In one implementation, searches for files by key words in the content of the file can be accelerated by including such key words in meta-data associated with the file.

In one embodiment, filter driver 204 may transfer to the proper storage device controller a request for meta-data or data based on (1) the identity of the storage medium that stores meta-data or data and (2) a logical block address in the storage medium of the meta-data or data. For a meta-data access, an identified storage medium may be meta-data storage device 108 whereas for a data access, the identified storage medium may be mass storage device 106. For example, for mass storage device 106, the storage device controller may be mass storage device controller 206. For meta-data storage device 108, the storage device controller may be meta-data storage device controller 208.

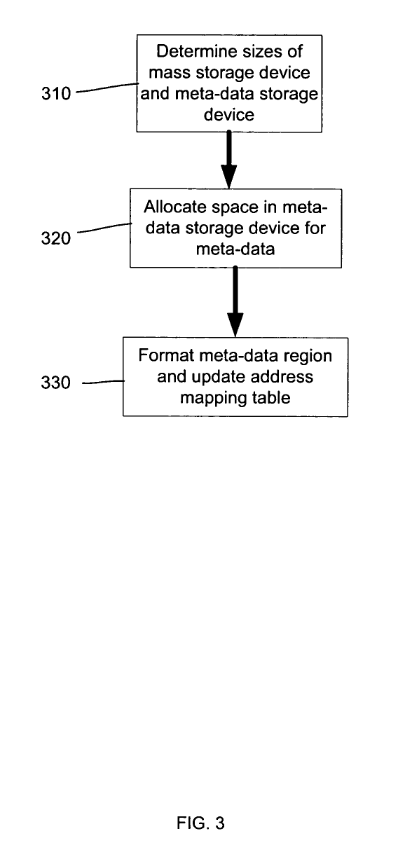

In one embodiment, filter driver 204 may request allocation for meta-data storage in meta-data storage device 108 in response, for example, to a request to access meta-data or a request to allocate meta-data storage in meta-data storage device 108. To initiate meta-data allocation, filter driver 204 may request meta-data storage controller 208 to reserve a storage region in meta-data storage device 108 for meta-data. For example, to request allocation for meta-data storage in meta-data storage device 108, the process described with respect to FIG. 3 may be used, although other techniques may be used.

Mass storage device controller 206 may manage reading and writing of data within mass storage device 106. Meta-data storage device controller 208 may manage the reading and writing of meta-data within meta-data storage device 108. Meta-data storage device controller 208 may reserve region(s) in meta-data storage device 108 for storing meta-data and update the address mapping table. Meta-data storage device controller 208 may modify region(s) reserved in meta-data storage device 108 for storing meta-data and may update the address mapping table. For example, meta-data storage device controller 208 may designate meta-data for storage in meta-data storage device 108 (e.g., mark meta-data as “do not evict”) but allow redundant copies in other storage devices.

FIG. 3 depicts an example process that can be used to reserve region(s) in meta-data storage device 108 for storing meta-data as well as to update the address mapping table, in accordance with an embodiment of the present invention. The process of FIG. 3 may be initiated at least in response to a request to initialize reservation of region(s) in meta-data storage device 108.

Action 310 may include determining available storage capacity of mass storage device 106 and meta-data storage device 108. For example, mass storage device controller 206 and meta-data storage device controller 208 may provide available storage capacity of respective mass storage device 106 and meta-data storage device 108.

Action 320 may include allocating a region of addressable locations in meta-data storage device 108 for storing meta-data. For example, based on the available storage capacity of mass storage device 106 and meta-data storage device 108, action 320 may determine a size and type of meta-data that can be stored in meta-data storage device 108. For example, action 320 may initially allocate file system type of meta-data, although other types of meta-data may be allocated.

Action 330 may include formatting the allocated region in the meta-data storage device 108 for meta-data storage in accordance with meta-data specifications, such as Microsoft file allocation table (FAT), Unix, and/or Linux file system ext family. Action 330 may further include updating the address mapping table to reflect the region allocated for storing meta-data in action 320.

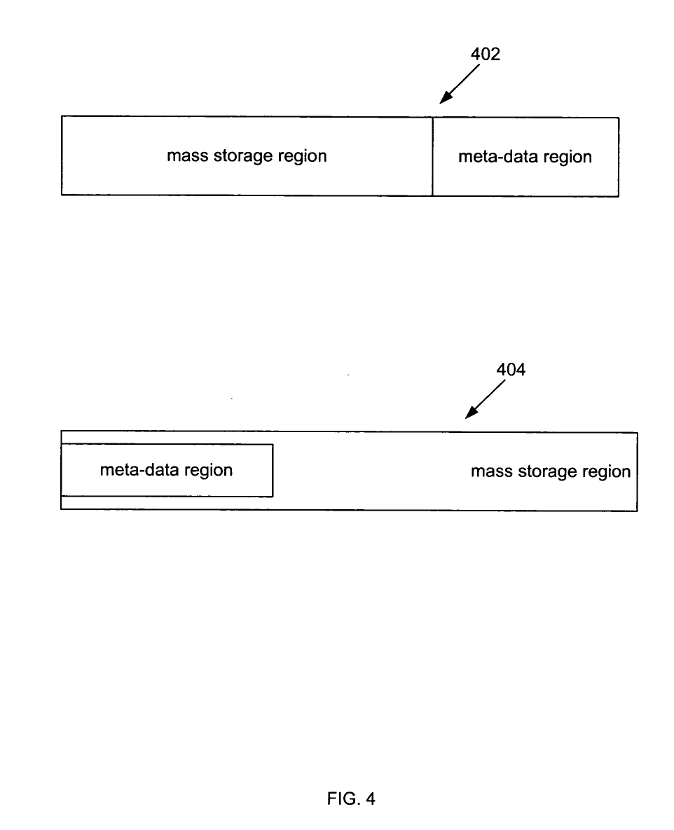

For example, FIG. 4 depicts examples of schemes that can be used for address mapping meta-data in mass storage device 106 and meta-data storage device 108, in accordance with embodiments of the present invention. In scheme 402, unique addresses are provided for storing meta-data in meta-data storage device 108 as well as for storing data in mass storage device 106. In scheme 404, an address for meta-data may correspond to an addressable storage location in both mass storage device 106 and meta-data storage device 108 so that meta-data may be stored in both mass storage device 106 and meta-data storage device 108. However, under scheme 404, in response to requests to access meta-data, meta-data may be accessed from meta-data storage device 108.

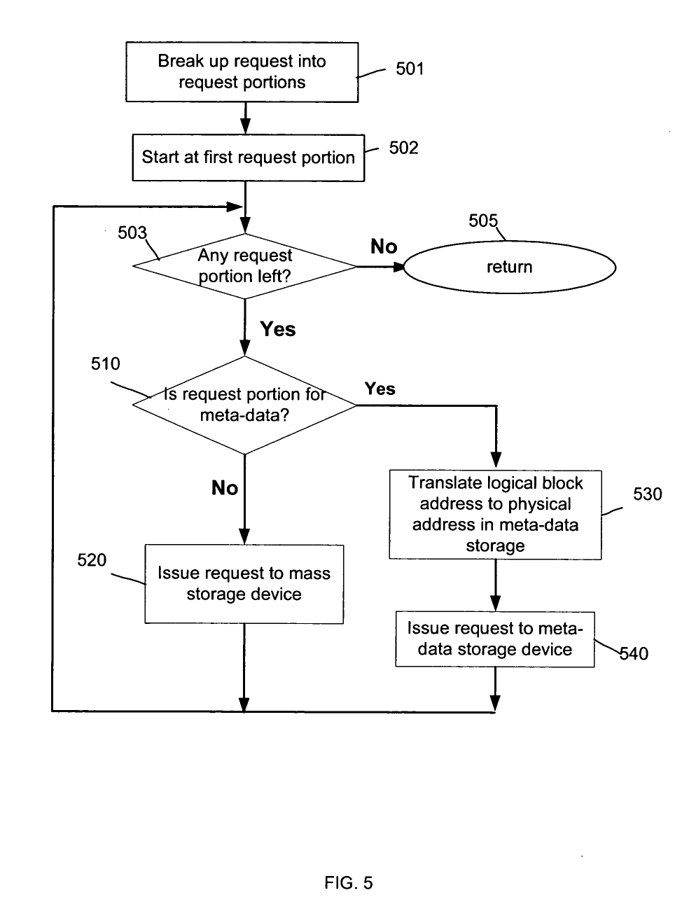

FIG. 5 depicts a process to access data and meta-data, in accordance with embodiments of the present invention. The system 200 of FIG. 2 may use the process of FIG. 5. Action 501 may include breaking up a file access request into request portions. A request for a file or directory access may be broken down into request portions that are either completely meta-data requests or completely data requests. For example, action 501 may include maximizing the amount of contiguous meta-data or data accessed (i.e., read or written) in each request portion from the same storage device (e.g., mass storage device 106 or meta-data storage device 108).

Action 502 may include processing a first request portion included with a file access request. Action 503 may follow action 502.

Action 503 may include determining whether any request portions have not been processed. If any request portion has not been processed, action 510 may follow action 503. If all request portions of the file access request have been processed, action 505 may follow action 503.

Action 505 may include returning to the routine that called the process of FIG. 5.

Action 510 may include determining whether a request portion is a request for meta-data. If the request portion includes a request for meta-data, then action 530 may follow action 510. If the request portion does not include a request for meta-data, then action 520 may follow action 510.

Action 520 may include issuing a request to access data stored at a specified logical block address to mass storage device 106.

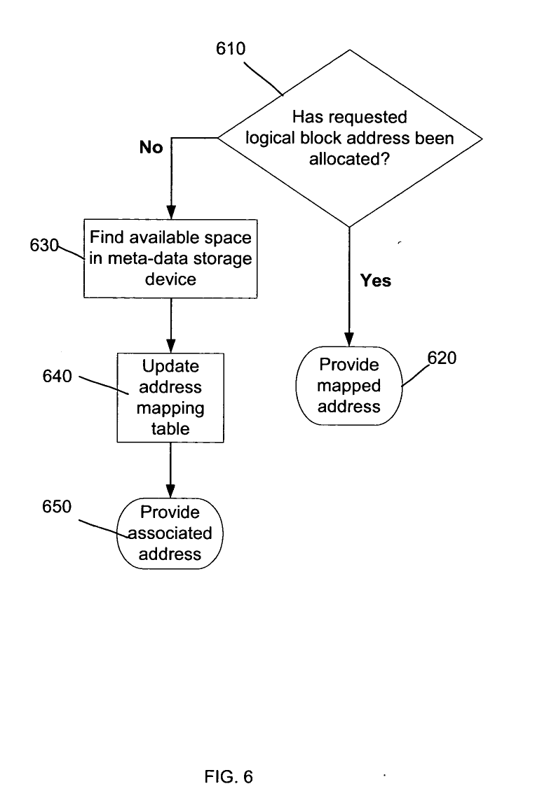

Action 530 may include translating a logical block address to a meta-data storage address. For example, action 530 may use the process described with respect to FIG. 6, although other techniques may be used. Action 540 may follow action 530. Action 540 may include issuing a request to access meta-data from a storage location specified in action 530 from meta-data storage device 108.

FIG. 6 depicts a process to convert a logical block address to a physical address in a meta-data storage device, in accordance with embodiments of the present invention.

Action 610 may include querying the address mapping table to determine if the requested logical block address has been allocated. If the requested logical block address has been allocated in the address mapping table, action 620 may follow action 610. If the requested logical block address has not been allocated in the address mapping table, action 630 may follow action 610.

Action 620 may include providing from the address mapping table a physical address in meta-data storage device 108 associated with the provided logical block address.

Action 630 may include associating an available physical address in meta-data storage device 108 with the provided logical block address. In one embodiment, if no physical addresses are available in meta-data storage device 108 then an association of the provided logical block address with the available physical address in the mass storage device 106 may be made. Action 640 may follow action 630.

Action 640 may include updating the address mapping table to include the association(s) of the logical block address with the available physical address in the meta-data storage device 108 (or mass storage device 106, as the case may be) determined in action 630. Action 650 may follow action 640. Action 650 may include providing to the requesting routine or device the physical address in the meta-data storage device 108 (or mass storage device 106, as the case may be) associated with the provided logical block address.

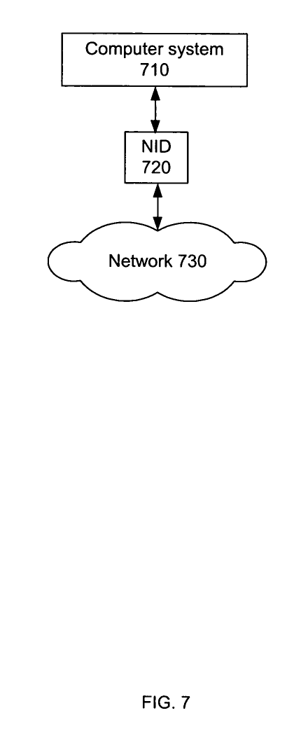

FIG. 7 depicts an example system in which some embodiments of the present invention may be used. The system of FIG. 7 may include a computer system 710, network interface device (NID) 720, and network 730. For example, computer system 710 may include system 100 or a similar system. NID 720 may provide intercommunication between computer system 710 and network 730. One implementation of NID 720 may include a media access controller (MAC) and a physical layer interface (both not depicted). NID 720 may be implemented as a Wake-on-LAN compatible network interface card or device compatible for example with the Microsoft network driver interface specification (NDIS) version 6.0 and later. Network 730 may be any network such as the Internet, an intranet, a local area network (LAN), storage area network (SAN), a wide area network (WAN), or wireless network. Network 730 may utilize any communications standards.

The drawings and the forgoing description gave examples of the present invention. While a demarcation between operations of elements in examples herein is provided, operations of one element may be performed by one or more other elements. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A method comprising:
allocating storage capacity for meta-data in a meta-data storage device;
processing a file-system level request by breaking up the request into at least one portion; and
satisfying each portion for meta-data from the meta-data storage device.

2. The method of claim 1, wherein the allocating storage capacity further comprises:
determining an initial region allocable for meta-data storage in the meta-data storage device;
formatting a region of the meta-data storage device for meta-data storage; and
recording associations between meta-data and storage locations of the meta-data.

3. The method of claim 1, wherein the processing the file-system level request further comprises:
selectively providing a first address in response to the portion comprising a meta-data request; and
selectively translating the first address into a second address in response to an association between the first and second addresses, wherein the second address identifies a storage location in the meta-data storage device.

4. The method of claim 3, wherein the translating further comprises:
selectively allocating a second address in available storage in the meta-data storage device in response to the first address not being associated with any address in the meta-data storage device; and
associating the first address with the allocated second address.

5. The method of claim 1, wherein the meta-data storage device comprises a non-volatile storage device with approximately similar access times for randomly requested meta-data.

6. The method of claim 1, wherein the meta-data storage device comprises a ferroelectric polymer memory.

7. The method of claim 1, wherein the meta-data storage device comprises a flash memory.

8. The method of claim 1, wherein the meta-data storage device comprises a resistive change polymer memory.

9. The method of claim 1, further comprising never evicting meta-data from storage in the meta-data storage device.

10. The method of claim 1, wherein the allocating storage capacity for meta-data comprises allocating addressable storage locations in the meta-data storage device and at least another storage device.

11. The method of claim 10, further comprising storing meta-data in the meta-data storage device and the at least another storage device.

12. The method of claim 1, wherein the meta-data comprises file system meta-data.

13. An apparatus comprising:
a storage medium storing therein instructions that cause a machine to execute the following operations:
allocate storage capacity for meta-data in a meta-data storage device;
process a file-system level request by breaking up the request into at least one portion; and
satisfy each portion for meta-data from the meta-data storage device.

14. The apparatus of claim 13, wherein the instruction that causes a machine to allocate storage capacity further comprises:
instructions that cause the machine to execute the following operations:
determine an initial region allocable for meta-data storage in the meta-data storage device;
format a region of the meta-data storage device for meta-data storage; and
record associations between meta-data and storage locations of the meta-data.

15. The apparatus of claim 13, wherein the instruction that causes a machine to process the file-system level request further comprises:
instructions that cause the machine to execute the following operations:
selectively provide a first address in response to the portion comprising a meta-data request; and
selectively translate the first address into a second address in response to an association between the first and second addresses, wherein the second address identifies a storage location in the meta-data storage device.

16. The apparatus of claim 15, wherein the instruction that causes a machine to translate further comprises:
instructions that cause the machine to execute the following operations:
selectively allocate a second address in available storage in the meta-data storage device in response to the first address not being associated with any address in the meta-data storage device; and
associate the first address with the allocated second address.

17. The apparatus of claim 13, wherein the meta-data storage device comprises a non-volatile storage device with approximately similar access times for randomly requested meta-data.

18. The apparatus of claim 13, wherein the meta-data storage device comprises a ferroelectric polymer memory.

19. An apparatus comprising:
logic circuitry to allocate storage capacity for meta-data in a meta-data storage device;
logic circuitry to process a file-system level request comprises logic circuitry to break up the request into at least one portion; and
logic circuitry to satisfy each portion for meta-data from the meta-data storage device.

20. The apparatus of claim 19, wherein the logic circuitry to allocate storage capacity further comprises:
logic circuitry to determine an initial region allocable for meta-data storage in the meta-data storage device;
logic circuitry to format a region of the meta-data storage device for meta-data storage; and
logic circuitry to record associations between meta-data and storage locations of the meta-data.

21. The apparatus of claim 19, wherein the logic circuitry to process the file-system level request further comprises:
logic circuitry to selectively provide a first address in response to the portion comprising a meta-data request; and
logic circuitry to selectively translate the first address into a second address in response to an association between the first and second addresses, wherein the second address identifies a storage location in the meta-data storage device.

22. The apparatus of claim 21, wherein the logic circuitry to translate further comprises:
logic circuitry to selectively allocate a second address in available storage in the meta-data storage device in response to the first address not being associated with any address in the meta-data storage device; and
logic circuitry to associate the first address with the allocated second address.

23. The apparatus of claim 19, wherein the meta-data storage device comprises a non-volatile storage device with approximately similar access times for randomly requested meta-data.

24. The apparatus of claim 19, wherein the meta-data storage device comprises a ferroelectric polymer memory.

25. The method of claim 19, wherein the meta-data storage device comprises a flash memory.

26. The method of claim 19, wherein the meta-data storage device comprises a resistive change polymer memory.

27. The apparatus of claim 19, wherein the meta-data storage device never evicts meta-data from storage.

28. A system comprising:
a processing unit;
a first storage device;
a second storage device;
an interface device to provide intercommunication between the processing unit and the first and second storage devices; and
a task storage device including machine readable instructions that when executed instruct the processing unit to:
allocate storage capacity for meta-data in a meta-data storage device;
process a file-system level request by breaking up the request into at least one portion; and
satisfy each portion for meta-data from the meta-data storage device.

29. The system of claim 28, wherein the interface device comprises an interface compatible with serial ATA.

30. The system of claim 28, wherein the interface device comprises an interface compatible with PCI express.

31. The system of claim 28, wherein the first storage device comprises a non-volatile storage device with approximately similar access times for randomly stored meta-data.

32. The system of claim 28, wherein the meta-data storage device comprises a non-volatile storage device with approximately similar access times for randomly requested meta-data.

33. The system of claim 28, wherein the meta-data storage device comprises a ferroelectric polymer memory.

34. The method of claim 28, wherein the meta-data storage device comprises a flash memory.

35. The method of claim 28, wherein the meta-data storage device comprises a resistive change polymer memory.
